(19) United States
(12) Patent Application Publication
(10) Pub. No.: US 2006/0283580 A1
(43) Pub. Date: Dec. 21, 2006

(54) Heat exchanger and process for fabricating same

(75) Inventor: Tadashi Usui, Tochigi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SHOWA DENKO K.K., Tokyo (JP)

(21) Appl. No.: 10/553,473

(22) PCT Filed: Apr. 15, 2004
(86) PCT No.: PCT/JP04/05401

§ 371 Date: Oct. 17, 2005

Related U.S. Application Data
(60) Provisional application No. 60/465,787, filed on Apr. 28, 2003.

(30) Foreign Application Priority Data
Apr. 16, 2003 (JP) 2003-111952

(51) Int. Cl. F28F 13/18; H01M 8/04; B21D 53/02

(52) U.S. Cl. 165/133; 429/26; 29/890.03

(57) ABSTRACT

A flat hollow body having a fluid channel inside thereof is made from two plates 2 serving as heat exchanger components, by brazing the plates at the peripheral edge portions thereof. The plate 2 comprises a core layer 21 of aluminum or aluminum alloy, and an Al—Si alloy layer 22 covering each of opposite sides of the core layer 21. The core layer 21 contains Si diffusing thereinto from the Al—Si alloy layer 22. The alloy layer 22 has a portion up to 1.65 mass % in Si content. The flat hollow body has high corrosion resistance.

### CROSS REFERENCE TO RELATED APPLICATIONS

This application is an application filed under 35 U.S.C. §111 (a) claiming the benefit pursuant to 35 U.S.C. §119(e) (1) of the filing date of Provisional Application No. 60/465,787 filed Apr. 28, 2003 pursuant to 35 U.S.C. §111(b).

### TECHNICAL FIELD

The present invention relates to heat exchanges and a process for fabricating the same, and more particularly to heat exchangers suitable for use in fuel cell systems useful, for example, for fuel cell motor vehicles or cogeneration systems for reducing the CO concentration of fuel gas (hydrogen gas) produced by a reformer.

The term “fluoride layer” as used herein and in the appended claims refers to a layer made substantially from a fluoride.

### BACKGROUND ART

Fuel cell systems are adapted to produce hydrogen gas containing a relatively large amount of CO by a reformer from a lower hydrocarbon gas such as methane or propane, gasoline, methanol or like fuel, to reduce the CO concentration of the hydrogen gas stepwise by a plurality of heat exchangers to obtain hydrogen gas of high purity and to generate electric power with the pure hydrogen gas using a fuel cell.

CO diminishing heat exchangers generally in use for fuel cell systems are those made from stainless steel in view of heat resistance and corrosion resistance, while it appears feasible to use pure aluminum or an aluminum alloy for making the CO diminishing heat exchanger to be disposed at the most downstream position in view of the reaction temperature of about 130 to about 140° C. and in order to ensure a cost reduction and a reduction in weight. However, the fuel hydrogen gas produced by the reformer contains an acid gas component, and the drain water produced by the CO diminishing heat exchanger has an acidity of 3 to 4 in pH, so that the heat exchanger must be given high corrosion resistance by a surface treatment.

A surface treatment process is already known for giving high corrosion resistance to pure aluminum or an aluminum alloy by fluorinating the surface of the pure aluminum or aluminum alloy material with fluorine gas and thereby forming a passive fluoride film (see, for example, the publication of JP-A No. 1990-263972, claims).

The CO diminishing heat exchanger of pure aluminum or aluminum alloy comprises a plurality of parallel flat hollow bodies each having a fluid channel inside thereof, and corrugated aluminum alloy fins interposed between respective pairs of adjacent hollow bodies and brazed thereto, each of the flat hollow bodies comprising two plates brazed to each other at the peripheral edge portions thereof, the two plates being bulged to define therebetween the fluid channel and header-forming portions communicating with respective opposite ends of the channel. Water containing a long-life coolant flows through the fluid channels inside the flat hollow bodies, and fuel hydrogen gas produced by a reformer flows through clearances between the respective pairs of adjacent flat hollow bodies.

Such a CO diminishing heat exchanger is fabricated by making plates each having a channel-forming bulging portion and a header-forming bulging portion extending from each of opposite ends of the channel-forming bulging portion and having a greater width than the bulging portion, from a brazing sheet comprising a core, for example, of JIS A3003 alloy and a cladding made of JIS A4004 alloy brazing material and covering each of opposite sides of the core, arranging the plates in superposed pairs each comprising the combination of two plates with openings of the bulging portions of each type opposed to each other in corresponding relation so that the outer surfaces of bottom walls of the header-forming bulging portions of the adjacent pairs are in contact with each other and arranging corrugated fins of bare JIS A3003 alloy between portions corresponding to the channel-forming bulging portions of the respective adjacent pairs of plates, and brazing the two plates in each pair to each other along the peripheral edge portions thereof to form a flat hollow body and brazing the corrugated fins to the respective adjacent pairs of flat hollow bodies. It is thought useful to form a fluoride layer over the outer peripheral surfaces of the flat hollow bodies and the surfaces of the fins by the process disclosed in the above publication, i.e., by heating the brazed assembly of the flat hollow bodies and the fins in an atmosphere containing fluorinating gas.

However, before the fluoride layer is formed on the heat exchanger assembly obtained by the above fabrication method, an Al—Si alloy layer having an Si content of 10 wt. % is formed in the surface layer of outer periphery of the flat hollow bodies, and this Al—Si alloy layer contains an Al—Si eutectic (Al-12 wt. % Si eutectic). Accordingly, Si reacts with F to form the compound of SiF₄ in the subsequent process of fluorination, and this compound evaporates, consequently making it impossible to uniformly form the fluoride layer of required thickness over the outer peripheral surfaces of the flat hollow bodies. The flow of the fuel hydrogen gas containing an acid gas component and produced by the reformer through the clearances between the adjacent flat hollow bodies produces drain water of pH 3 to 4. The drain water entails the problem of causing corrosion to the outer peripheral surfaces of the flat hollow bodies, permitting the corrosion to develop to the JIS A3003 alloy forming the core of the hollow bodies. The corrosion of outer peripheral surfaces of the flat hollow bodies develops from crystal grain boundaries of the remaining Al-12 wt. % Si eutectic.

An object of the present invention is to overcome the foregoing problem and to provide a heat exchanger having high corrosion resistance and a process for fabricating the same.

### DISCLOSURE OF THE INVENTION

To fulfill the above object, the present invention comprises the following modes.

1) A heat exchanger comprising a heat exchanger component having a surface covered with an Al—Si alloy layer, the Al—Si alloy layer having a fluoride layer formed in a surface layer portion thereof, the Al—Si alloy layer of the heat exchanger component having a portion up to 1.65 mass % in Si content.

2) A heat exchanger set forth in the above para. 1) wherein the fluoride layer is 2 nm to 10 μm in thickness.

3) A heat exchanger set forth in the above para. 1) wherein the fluoride layer comprises a fluoride produced by subjecting a surface of the Al—Si alloy layer of the heat exchanger component to a fluorination treatment.

4) A heat exchanger set forth in the above para. 1) wherein an anodic oxide coating is formed over a surface of the Al—Si alloy layer of the heat exchanger component, and a plating layer containing nickel is formed on a surface of the anodic oxide coating, the fluoride layer being formed over a surface of the plating layer and comprising a fluoride produced by subjecting the surface of the plating layer to a fluorination treatment.

5) A heat exchanger set forth in the above para. 1) wherein the fluoride layer is provided over a surface thereof with at least one superposed layer group comprising a plating layer containing nickel and a fluoride layer comprising a fluoride produced by subjecting a surface of the plating layer to a fluorination treatment.

6) A heat exchanger set forth in the above para. 1) wherein the heat exchanger component comprises a core layer of pure aluminum or aluminum alloy, and an Al—Si alloy layer covering each of opposite surfaces of the core layer, the core layer containing Si diffused thereinto from the Al—Si alloy layer, the Al—Si alloy layer having a portion up to 1.65 mass % in Si content.

7) A heat exchanger set forth in the above para. 6) wherein at least one surface of the heat exchanger component is exposed to a fluid containing an acid component.

8) A heat exchanger set forth in the above para. 1) wherein the heat exchange component has a portion comprising a core layer of pure aluminum or aluminum alloy, and two Al—Si alloy layers covering respective opposite surfaces of the core layer, and an intermediate layer of pure aluminum is formed between one of the Al—Si alloy layers and the core layer, the intermediate layer containing Si diffused thereinto from the Al—Si alloy layer, the Al—Si alloy layer adjacent to the intermediate layer having a portion up to 1.65 mass % in Si content.

9) A heat exchanger set forth in the above para. 1) wherein the heat exchange component comprises a core layer of pure aluminum or aluminum alloy, and two Al—Si alloy layers covering respective opposite surfaces of the core layer, and an intermediate layer of pure aluminum is formed between each of the Al—Si alloy layers and the core layer, the intermediate layer containing Si diffused thereinto from the Al—Si alloy layer, the Al—Si alloy layer having a portion up to 1.65 mass % in Si content.

10) A heat exchanger set forth in the above para. 8) or 9) wherein the pure aluminum making the intermediate layer has added thereto Zr and/or Mg in a total amount of 0.1 to 0.25 mass %.

11) A heat exchanger set forth in the above para. 8) or 9) wherein the intermediate layer has a thickness in a proportion of 5 to 25% of the entire thickness taken as 100% of the heat exchanger component.

12) A heat exchanger set forth in the above para. 8) or 9) wherein a surface of the heat exchanger component on the side thereof where the intermediate layer exists is exposed to a fluid containing an acid component.

13) A heat exchanger set forth in the above para. 1) which comprises a plurality of parallel hollow bodies each having a fluid channel inside thereof and fins arranged between and brazed to respective pairs of adjacent flat hollow bodies, the heat exchanger component being each of the flat hollow bodies.

14) A heat exchanger set forth in the above para. 1) which comprises a plurality of parallel hollow bodies each having a fluid channel inside thereof and fins arranged between and brazed to respective pairs of adjacent flat hollow bodies, each of the hollow bodies comprising two plates brazed to each other at peripheral edge portions thereof, the two plates defining therebetween a bulging fluid channel and a bulging header-forming portion communicating with each of opposite ends of the fluid channel, the heat exchanger component being each of the plates.

15) A heat exchanger set forth in the above para. 13) or 14) wherein a fluid containing an acid component flows through at least one of the fluid channel inside each of the flat hollow bodies and a clearance between each pair of adjacent flat hollow bodies.

16) A heat exchanger set forth in the above para. 13) or 14) wherein fuel hydrogen gas produced by reforming in a fuel cell system flows through a clearance between each pair of adjacent flat hollow bodies, and an outer peripheral surface of each of the flat hollow bodies is covered with an Al—Si alloy layer, a fluoride layer being formed in a surface layer portion of the Al—Si alloy layer, the Al—Si alloy layer having a portion up to 1.65 mass % in Si content, a catalyst for selectively oxidizing CO being provided on the outer peripheral surface of each of the flat hollow bodies and on a surface of each of the fins, the catalyst being serviceable to diminish CO in the fuel hydrogen gas.

17) A fuel cell system comprising a heat exchanger set forth in any one of the above para. 1) to 16) for diminishing CO.

18) A fuel cell motor vehicle having installed therein a fuel cell system set forth in the above para. 17).

19) A cogeneration system comprising a fuel cell system set forth in the above para. 17).

20) A process for fabricating a heat exchanger characterized by making plates each having a channel-forming bulging portion and a header-forming bulging portion bulging to a greater extent than the bulging portion and extending from each of opposite ends of the channel-forming bulging portion, from a brazing sheet comprising a core of pure aluminum or aluminum alloy and a cladding of Al-7.5-12.5 wt. % Si alloy brazing material covering each of opposite sides of the core, arranging the plates in superposed pairs each comprising the combination of two plates with openings of the bulging portions of each type opposed to each other in corresponding relation so that outer surfaces of bottom walls of the header-forming bulging portions of the adjacent pairs are in contact with each other and arranging fins of bare pure aluminum or aluminum alloy between portions corresponding to the channel-forming bulging portions of the respective adjacent pairs of plates, preheating the resulting combination of the pairs of plates and the fins to diffuse the Si in the cladding of the brazing sheet providing the plates through the core, brazing the two preheated plates in each pair to each other along the peripheral edge portions thereof to form a flat hollow body, brazing the fins to the respective adjacent pairs of flat hollow bodies, and heating the brazed assembly of the flat hollow bodies and the fins in an atmosphere containing a fluorinating gas to form a fluoride layer over surfaces of the flat hollow bodies and surfaces of the fins.

21) A process for fabricating a heat exchanger characterized by making plates each having a channel-forming bulging portion and a header-forming bulging portion bulging to a greater extent than the bulging portion and extending from each of opposite ends of the channel-forming bulging portion, from a brazing sheet comprising a core of pure aluminum or aluminum alloy, a cladding of Al-7.5-12.5 wt. % Si alloy brazing material covering each of opposite sides of the core, and an intermediate layer of pure aluminum formed between the core and the cladding over at least one of the opposite sides thereof, arranging the plates in superposed pairs each comprising the combination of two plates with openings of the bulging portions of each type opposed to each other in corresponding relation so that outer surfaces of bottom walls of the header-forming bulging portions of the adjacent pairs are in contact with each other and arranging fins of bare pure aluminum or aluminum alloy between portions corresponding to the channel-forming bulging portions of the respective adjacent pairs of plates, preheating the resulting combination of the pairs of plates and the fins to diffuse the Si in the cladding of the brazing sheet providing the plates through the core, brazing the two preheated plates in each pair to each other along the peripheral edge portions thereof to form a flat hollow body, brazing the fins to the respective adjacent pairs of flat hollow bodies, and heating the brazed assembly of the flat hollow bodies and the fins in an atmosphere containing a fluorinating gas to form a fluoride layer over a surface of each of the flat hollow bodies on the core side thereof where the intermediate layer exists and over surfaces of the fins.

22) A process for fabricating a heat exchanger set forth in the above para. 21) wherein the pure aluminum providing the intermediate layer of the brazing sheet making the plates has added thereto Zr and/or Mg in a total amount of 0.1 to 0.25 mass %.

23) A process for fabricating a heat exchanger set forth in the above para. 21) wherein the intermediate layer of the brazing sheet providing the plates has a thickness in a proportion of 5 to 25% of the entire thickness taken as 100% of the brazing sheet.

24) A process for fabricating a heat exchanger set forth in the above para. 20) or 21) wherein the core of the brazing sheet providing the plates and the fins are each made of JIS A3003 alloy.

25) A process for fabricating a heat exchanger set forth in the above para. 20) or 21) wherein the cladding of the brazing sheet providing the plates has a thickness in a proportion of 2 to 25% of the entire thickness taken as 100% of the brazing sheet.

26) A process for fabricating a heat exchanger set forth in the above para. 20) or 21) wherein the fluorinating gas is at least one gas selected from the group consisting of fluorine gas, chlorine trifluoride gas and nitrogen fluoride gas, and the fluorinating gas is diluted with an inert gas to prepare the atmosphere.

27) A process for fabricating a heat exchanger set forth in the above para. 26) wherein the atmosphere contains the fluorinating gas at a concentration of 5 to 80%.

28) A process for fabricating a heat exchanger set forth in the above para. 26) wherein the atmosphere contains the fluorinating gas at a concentration of 10 to 60%.

29) A process for fabricating a heat exchanger set forth in the above 20) or 21) wherein a catalyst for selectively oxidizing CO is provided on outer peripheral surfaces of the flat hollow bodies and on surfaces of the fins after the fluoride layer is formed.

30) A product of pure aluminum or aluminum alloy comprising a component having a surface covered with an Al—Si alloy layer, the Al—Si alloy layer having a fluoride layer formed on a surface layer portion thereof, the Al—Si alloy layer of the component having a portion up to 1.65 mass % in Si content.

31) A product of pure aluminum or aluminum alloy in the above-para. 30) wherein the fluoride layer is 2 nm to 10 μm in thickness.

32) A product of pure aluminum or aluminum alloy in the above para. 30) wherein the fluoride layer comprises a fluoride produced by subjecting a surface of the Al—Si alloy layer of the component to a fluorination treatment.

33) A product of pure aluminum or aluminum alloy set forth in the above para. 30) wherein an anodic oxide coating is formed over a surface of the Al—Si alloy layer of the component, and a plating layer containing nickel is formed over a surface of the anodic oxide coating, the fluoride layer being formed over a surface of the plating layer and comprising a fluoride produced by subjecting the surface of the plating layer to a fluorination treatment.

34) A product of pure aluminum or aluminum alloy in the above para. 30) wherein the fluoride layer is provided over a surface thereof with at least one superposed layer group comprising a plating layer containing nickel and a fluoride layer comprising a fluoride produced by subjecting a surface of the plating layer to a fluorination treatment.

35) A product of pure aluminum or aluminum alloy in the above para. 30) wherein the component comprises a core layer of pure aluminum or aluminum alloy, and an Al—Si alloy layer covering each of opposite surfaces of the core layer, the core layer containing Si diffused thereinto from the Al—Si alloy layer, the Al—Si alloy layer having a portion up to 1.65 mass % in Si content.

36) A product of pure aluminum or aluminum alloy in the above para. 35) wherein at least one surface of the component is exposed to a fluid containing an acid component or alkaline component.

37) A product of pure aluminum or aluminum alloy set forth in the above para. 30) wherein the component has a portion comprising a core layer of pure aluminum or aluminum alloy, and two Al—Si alloy layers covering respective opposite surfaces of the core layer, and an intermediate layer of pure aluminum is formed between one of the Al—Si alloy layers and the core layer, the intermediate layer containing Si diffused thereinto from the Al—Si alloy layer, the Al—Si alloy layer adjacent to the intermediate layer having a portion up to 1.65 mass % in Si content.

38) A product of pure aluminum or aluminum alloy set forth in the above para. 30) wherein the component comprises a core layer of pure aluminum or aluminum alloy, and two Al—Si alloy layers covering respective opposite surfaces of the core layer, and an intermediate layer of pure aluminum is formed between each of the Al—Si alloy layers and the core layer, the intermediate layer containing Si diffused thereinto from the Al—Si alloy layer, the Al—Si alloy layer having a portion up to 1.65 mass % in Si content.

39) A product of pure aluminum or aluminum alloy set forth in the above para. 37) or 38) wherein the pure aluminum making the intermediate layer has added thereto Zr and/or Mg in a total amount of 0.1 to 0.25 mass %.

40) A product of pure aluminum or aluminum alloy set forth in the above para. 37) or 38) wherein the intermediate layer has a thickness in a proportion of 5 to 25% of the entire thickness taken as 100% of the component.

41) A product of pure aluminum or aluminum alloy set forth in the above para. 37) or 38) wherein a surface of the component on the side thereof where the intermediate layer exists is exposed to a fluid containing an acid component or alkaline component.

The present invention includes the following modes.

a) A brazing sheet for use in fabricating heat exchangers which comprises a core of pure aluminum or aluminum alloy, two claddings of Al-7.5-12.5 mass % Si alloy covering respective opposite surfaces of the core, and an intermediate layer of pure aluminum formed between one of the claddings and the core.

b) A brazing sheet for use in fabricating heat exchangers which is set forth in the above para. a) and wherein the pure aluminum making the intermediate layer has added thereto Zr and/or Mg in a total amount of 0.1 to 0.25 mass %.

c) A brazing sheet for use in fabricating heat exchangers which is set forth in the above para. a) or b) and wherein the intermediate layer has a thickness in a proportion of 5 to 25% of the entire thickness taken as 100% of the brazing sheet.

d) A brazing sheet for use in fabricating heat exchangers which is set forth in any of the above para. a) to c) and wherein the core is made of JIS A3003 alloy.

e) A brazing sheet for use in fabricating heat exchangers which is set forth in any one of the above para. a) to d) and wherein the cladding has a thickness in a proportion of 2 to 25% of the entire thickness taken as 100% of the brazing sheet.

With the heat exchanger set forth in the above para. 1), the Al—Si alloy layer of the heat exchanger component has a portion up to 1.65 mass % in Si content. Accordingly, the Al—Si alloy layer is almost unlikely to contain Al-12 mass % Si eutectic, SiF₄ is inhibited in conducting a fluorination treatment for forming the fluoride layer, and the fluoride layer can be formed uniformly with a required thickness. The heat exchanger component is therefore given high corrosion resistance. Further because Al-12 mass % Si eutectic is almost unlikely to exist in the Al—Si alloy layer, development of corrosion from crystal grain boundaries of the eutectic to the core layer which is positioned inwardly of the Al—Si alloy layer can be prevented even if the component is exposed to a fluid having an acid component in the case where the fluoride layer has faults.

The heat exchanger described in the above para. 2) is available at a reduced cost and yet has high corrosion resistance against acids.

With the heat exchanger described in the above para. 4) or 5), the heat exchanger component is further improved in corrosion resistance against acids.

With the heat exchanger set forth in the above para. 6), the Si of the Al—Si alloy-layer is diffused into the core layer, consequently giving an Si content of up to 1.65 mass % to a major portion of the Al—Si alloy layer and permitting the heat exchanger to have the same advantage as the heat exchanger of the para. 1).

With the heat exchanger set forth in the above para. 7), corrosion is inhibited even when the heat exchanger component is exposed to a fluid having an acid component.

With the heat exchanger set forth in the above para. 8) or 9), the Si of the Al—Si alloy layer is diffused into the intermediate layer, thereby giving an Si content of up to 1.65 mass % to a major portion of the Al—Si alloy layer and permitting the heat exchanger to exhibit the same advantage as the heat exchanger of the para. 1).

With the heat exchanger set forth in the above para. 10), the intermediate layer has pure aluminum crystal grains of increased sizes, and Al-12 mass % Si eutectic is no longer produced even in the layer into which Si diffuses from the Al—Si alloy layer. This results in improved corrosion resistance.

With the heat exchangers set forth in the para. 13) to 15), a fluid containing an acid component will flow through at least one of the fluid channel inside each flat hollow body and the clearance between each pair of adjacent flat hollow bodies. The surfaces of the flat hollow bodies to be exposed to the fluid in this case are covered with the Al—Si alloy layer a major portion of which is up to 1.65 mass % in Si content, and a fluoride layer is formed in the surface layer portion of the Al—Si alloy layer. This structure prevents the corrosion of the hollow bodies that would result from exposure to the fluid having an acid component.

With the heat exchanger described in the above para. 16), the fuel hydrogen gas produced by reforming and containing an acid gas is passed through the exchanger. The surfaces of the flat hollow bodies to be exposed to the fuel hydrogen gas are covered with the Al—Si alloy layer a major portion of which is up to 1.65 in Si content, and the fluoride layer is formed in a surface layer portion of the Al—Si alloy layer. The flat hollow bodies are prevented from corroding owing to the fluid having an acid component.

With the process set forth in the above para. 20) for fabricating a heat exchanger, preheating of the assembly to be brazed causes the Si in the cladding of the brazing sheet providing the plates to diffuse into the core. Accordingly, the cladding is unlikely to contain Al-12 mass % Si eutectic, SiF₄ is inhibited in conducting a fluorination treatment for forming the fluoride layer after brazing, and the fluoride layer can be formed uniformly with a required thickness. Further because Al-12 mass % Si eutectic is unlikely to exist in the cladding, development of corrosion from crystal grain boundaries of Al-12 mass % Si eutectic to the cladding can be prevented even if the heat exchanger is exposed to a fluid having an acid component in the case where the fluoride layer has faults.

With the process set forth in the above para. 21) for fabricating a heat exchanger, the Si in the cladding diffuses into the intermediate layer during brazing. Accordingly, the cladding is unlikely to contain Al-12 mass % Si eutectic, SiF₄ is inhibited in conducting a fluorination treatment for forming the fluoride layer after brazing, and the fluoride layer can be formed uniformly with a required thickness. Further because Al-12 mass % Si eutectic is unlikely to exist in the cladding, development of corrosion from crystal grain boundaries of Al-12 mass % Si eutectic to the intermediate layer and to the cladding can be prevented even if the heat exchanger is exposed to a fluid having an acid component in the case where the fluoride layer has faults.

With the process set forth in the above para. 22) for fabricating a heat exchanger, the intermediate layer has pure aluminum crystal grains of increased sizes, and Al-12 mass % Si eutectic is no longer produced even in a diffused layer which is formed by the diffusion of Si from the cladding into the intermediate layer. This results in improved corrosion resistance.

With the process set forth in the above para. 27) or 28) for fabricating a heat exchanger, the exchanger is available at a reduced production cost, and the fluoride layer of required thickness can be formed relatively promptly.

The pure aluminum or aluminum alloy product described in the para. 30) has the same advantage as the heat exchanger of the para. 1).

The pure aluminum or aluminum alloy product described in the para. 31) has the same advantage as the heat exchanger of the para. 2).

The pure aluminum or aluminum alloy products described in the para. 33) to 39) have the same advantage as the heat exchanger of the para. 4).

### BRIEF DESCRIPTION OF THE DRAWINGS

FIG. 1 is a perspective view showing an embodiment of heat exchanger of the invention.

FIG. 2 is a fragmentary perspective view partly broken away and showing the heat exchanger of FIG. 1 on an enlarged scale.

FIG. 3 is an enlarged sectional view showing a plate for making a flat hollow body of the heat exchanger of FIG. 1.

FIG. 4 is an enlarged sectional view showing a modified plate for making the flat hollow body of the heat exchanger of FIG. 1. FIG. 5 is an enlarged sectional view showing another modified plate for making the flat hollow body of the heat exchanger of FIG. 1.

FIG. 6 is an enlarged sectional view showing a still another modified plate for making the flat hollow body of the heat exchanger of FIG. 1.

FIG. 7 is a photograph showing the result of Experimental Example 1.

FIG. 8 is a graph showing the results of Experimental Examples 6 and 7 and Comparative Experimental Examples 3 to 5.

FIG. 9 is a photograph showing the result of Experimental Example 8.

### BEST MODE OF CARRYING OUT THE INVENTION

Embodiments of the present invention will be described below with reference to the drawings.

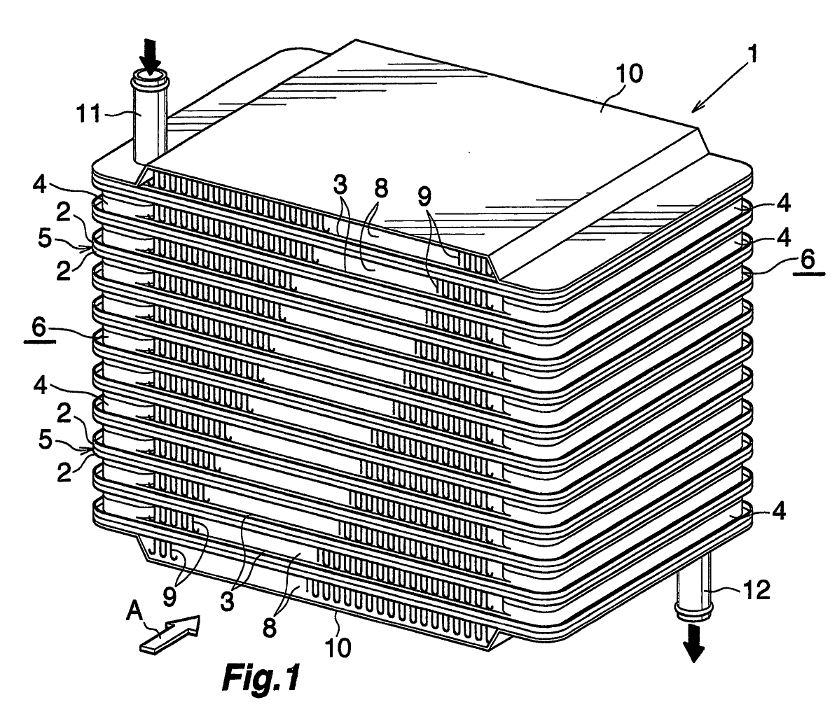

Incidentally in the following description, the upper, lower sides and left- and right-hand sides of FIG. 1 will be referred to as “upper,” “lower,” “left” and “right,” respectively.

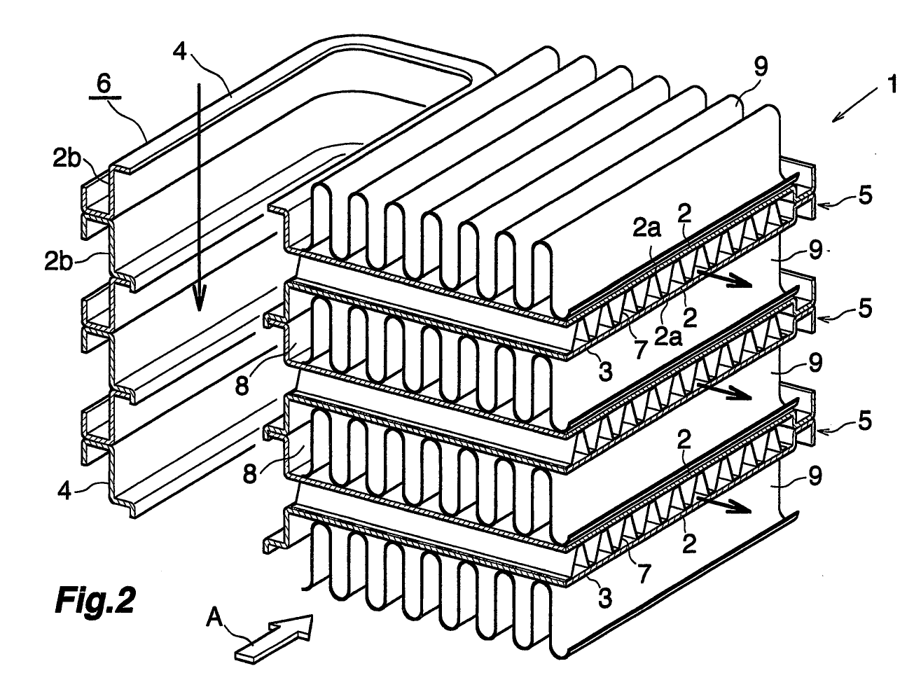

FIG. 1 shows the overall construction of a heat exchanger embodying the invention, and FIGS. 2 and 2 are fragmentary views of the same.

With reference to FIGS. 1 and 2, a heat exchanger 1 comprises a plurality of parallel flat hollow bodies 5 each composed of two dishlike plates 2 brazed to each other at their peripheral edge portions and defining therebetween a bulging fluid channel 3 and two bulging header-forming portions 4 extending respectively from opposite left and right ends of the channel 3.

The fluid channel 3 and the bulging header-forming portions 4 are formed by arranging two plates 2, each having a channel-forming bulging portion 2a and two header-forming bulging portions 2b extending from respective opposite ends of the portion 2a, as opposed to each other, with the openings of these portions 2a, 2b of one of the plates 2 facing toward like openings of the other plate 2 in corresponding relation. The header-forming portions 4 of the flat hollow body 5 have a height larger than the height of the fluid channel 3 thereof, and the corresponding header-forming portions 4 of the adjacent flat hollow bodies 5 are in communication with each other to provide a header 6 at each of the left and right ends of the exchanger. The fluid channel 3 has disposed therein an inner corrugated fin 7 of bare material of pure aluminum or aluminum alloy and brazed to the two plates 2. A clearance between portions corresponding to the fluid channels 3 of the adjacent flat hollow bodies 5 serves as a gas-phase fluid channel 8 having disposed therein an outer corrugated fin 9 made of bare material of pure aluminum or aluminum alloy and brazed to the hollow bodies 5. A side plate 10 of bare material of pure aluminum or aluminum alloy is disposed externally of and spaced apart from a portion of the flat hollow body at each of upper and lower ends of the heat exchanger which portion corresponds to the fluid channel 3 thereof. The space between the side plate 10 and the hollow body 5 at each of upper and lower ends serves also as a gas-phase fluid channel 8. An outer corrugated fin 9 is provided also in this gas-phase fluid channel 8 and brazed to the hollow body 5 and the side plate 10. The side plate 10 has its opposite ends vertically bent inward and brazed to the header-forming portions 4 of the end hollow body 5. A fluid inlet pipe 11 is joined to an upper end portion of the header 6 at the left, and a fluid outlet pipe 12 to a lower end portion of the header 6 at the right. The fluid flowing into the header 6 at the left through the inlet pipe 11 dividedly flows through the fluid channels 3 of all the flat hollow bodies 5 into the header 6 at the right, and is sent out of the outlet pipe 12.

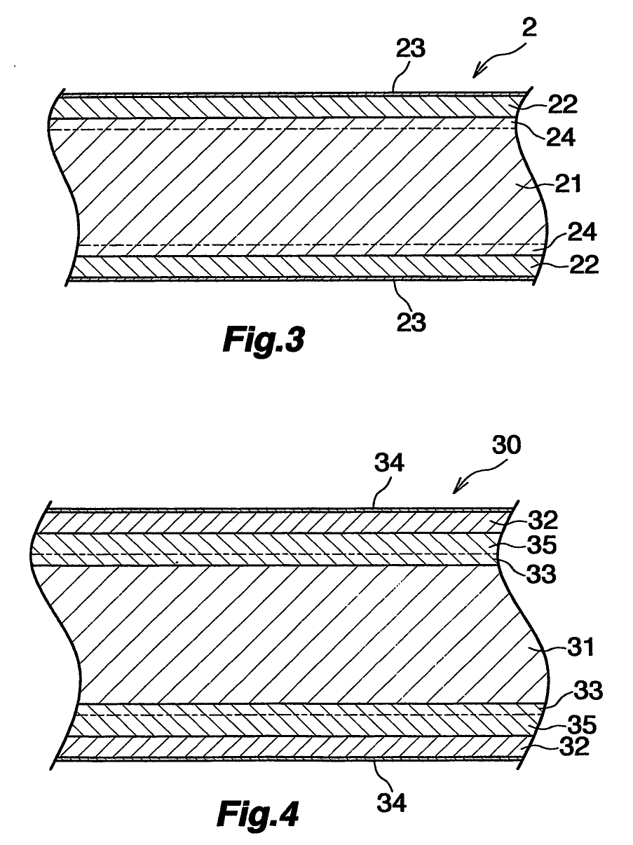

According to the present embodiment, the plate 2 making the flat hollow body 5 is a heat exchange component of the invention. With reference to FIG. 3, the plate 2 comprises a core layer 21 of pure aluminum or aluminum alloy, i.e., JIS A3003 alloy according to the present embodiment, an Al—Si alloy layer 22 covering each of opposite surfaces of the core layer 21, and a fluoride layer 23 formed in a surface layer portion of the alloy layer 22. The material for forming the core layer 21 is not limited to JIS A3003 alloy.

Si is diffused from the Al—Si alloy layer 22 into the core layer 21. The diffused layer is indicated at 24. A major portion of the entire Al—Si alloy layer 22 is up to 1.65 mass % in Si content. In the portion of the plate 2 having a fillet formed by brazing the corrugated fins 7, 9 thereto, or the portion of the plate 2 where the plate is bent, the Si content of the Al—Si alloy layer 22 may be in excess of 1.65 mass %, whereas the Al—Si alloy layer 22 in the other portion is up to 1.65 mass % in Si content. When a major portion of the entire Al—Si alloy layer 22 is up to 1.65 mass % in Si content, Al-12 mass % Si eutectic is unlikely to exist in the Al—Si alloy layer 22. Consequently, the fluoride layer 23 can be formed uniformly with a required thickness by a fluorination treatment, with SiF₄ inhibited. Further because Al-12 mass % Si eutectic is unlikely to exist in the Al—Si alloy layer 22, development of corrosion from crystal grain boundaries of the eutectic to the core layer 21 can be prevented even if a fluid having an acid component flows through the fluid channels 3 or gas-phase fluid channels 8 in the case where the fluoride layer 23 has faults.

The fluoride layer 23 comprises a fluoride produced by subjecting the surface of the Al—Si alloy layer 22 of the plate 2 to the fluorination treatment. Preferably, the fluoride layer 23 is 2 nm to 10 μm in thickness. If the fluoride layer 23 is less than 2 nm in thickness, sufficient corrosion resistance is not available against acids, permitting the plate to develop corrosion within a relatively short period of time. If the thickness is in excess of 10 μm, formation of the fluoride layer 23 requires much time to increase the production cost of the heat exchanger although satisfactory corrosion resistance is available. It is desired that the fluoride layer be 20 nm to 3 μm in thickness.

The heat exchanger 1 is used in a fuel cell system, for example, for use in fuel cell motor vehicles or cogeneration systems as a CO diminishing heat exchanger to reduce the CO concentration of the fuel hydrogen gas produced by a reformer. In this case, a catalyst (not shown) for selectively oxidizing CO is provided on the outer peripheral surfaces of the flat hollow bodies, i.e., on the outer surfaces of the plates 2 and the surfaces of the outer corrugated fins 9. This catalyst may be adhered as supported on a carrier to the outer surfaces of the plates 2 and the surfaces of the corrugated fins 9. Although not limitative, the catalyst to be used is, for example, a Cu—Zn catalyst or zeolite catalyst. The reaction of CO+1/2O₂→CO₂ is promoted by the catalyst to reduce the CO concentration of fuel hydrogen gas.

When the heat exchanger 1 is used for diminishing CO in fuel hydrogen gas, the fuel hydrogen gas is passed through the gas-phase fluid channels 8 (see FIG. 1, arrow A) and has its CO concentration catalytically reduced while being cooled with a refrigerant, e.g., water or water containing a long-life coolant, flowing through the fluid channels 8.

When the heat exchanger is used for diminishing CO, the Al—Si alloy layer 22 on the inner peripheral surfaces of the flat hollow bodies 5, i.e., on the inner surfaces of the plates 2, need not always be up to 1.65 mass % in Si content, nor is it necessary to provide the fluoride layer 23 in the surface layer portion of the alloy layer because the corrosion resistance of the Al—Si alloy layer has no problem when the layer is exposed to water or water containing a long-life coolant.

When a fluid containing an acid component is passed through both the fluid channels 3 and the gas-phase fluid channels 8, a major portion of the entire Al—Si alloy layer 22 on the inner and outer peripheral surfaces of the flat hollow bodies, i.e., the inner and outer surfaces of the plates 2, is given an Si content of up to 1.65 mass %, and a fluoride layer 23 is formed in the surface layer portion of the Al—Si alloy layer 22.

The heat exchanger 1 is fabricated by the process to be described below.

First, a three-layer brazing sheet is prepared which comprises a core of pure aluminum or aluminum alloy, i.e., JIS A3003 alloy according to the present embodiment, and a cladding covering each of opposite sides of the core and made of Al-7.5-12.5 mass % Si alloy brazing material, i.e., JIS A4004 alloy brazing material according to the embodiment. Plates 2 are prepared from the brazing sheet by press work, each of the plates 2 having a channel-forming bulging portion 2a and a header-forming bulging portion 2b bulging to a greater extent than the bulging portion 2a and extending from each of opposite ends of the bulging portion 2a. Preferably, the cladding of the brazing sheet has a thickness in a proportion of 2 to 25% of the entire thickness taken as 100% of the brazing sheet because if the thickness is outside this range, difficulty is encountered in producing the brazing sheet by rolling.

The plates 2 are then arranged in superposed pairs each comprising the combination of two plates 2 with openings of the bulging portions 2a (2b) of each type opposed to each other in corresponding relation so that the outer surfaces of bottom walls of the header-forming bulging portions 2b of the adjacent pairs are in contact with each other. Outer corrugated fins 9 of bare pure aluminum or aluminum alloy, i.e., JIS A3003 alloy according to the present embodiment, are arranged between portions corresponding to the channel-forming bulging portions 2a of the respective adjacent pairs of plates 2, and inner corrugated fins 7 of bare pure aluminum or aluminum alloy, i.e., JIS A3003 alloy according to the present embodiment, are arranged in the channel-forming bulging portions 2a of the respective pairs of plates 2.

The resulting combination of the pairs of plates 2 and the corrugated fins 7, 9 are subsequently preheated to diffuse the Si in the cladding of the brazing sheet providing the plates 2 into the core to give an Si content of up to 1.65 mass % to the cladding. This preheating is effected, with the preheating time and/or temperature for the usual brazing operation altered. For example, the preheating time for the usual brazing operation is increased to 1.5 to 2 times when the preheating time is altered. The preheating temperature for the usual brazing operation is raised when the preheating temperature is altered.

The two preheated plates 2 in each pair are thereafter brazed to each other along the peripheral edge portions thereof to form a flat hollow body 5, and the corrugated fins 7, 9 are brazed to the flat hollow bodies 5.

The brazed assembly of the flat hollow bodies 5 and the corrugated fins 7, 9 is then heated in an atmosphere containing a fluorinating gas to form a fluoride layer 23 over the inner and outer peripheral surfaces of the flat hollow bodies 5, i.e., the inner and outer surfaces of the plates 2, and the surfaces of the corrugated fins 7, 9. The fluorinating gas is at least one gas selected from the group consisting of fluorine gas, chlorine trifluoride gas and nitrogen fluoride gas. The fluorinating gas is diluted with an inert gas to prepare the fluorinating atmosphere. Preferably, this atmosphere has the fluorinating gas at a concentration of 5 to 80%. If the concentration of the fluorinating gas in the atmosphere is less than 5%, it is impossible to form the fluoride layer 23 of required thickness, and it is difficult to obtain the desired corrosion resistance. The greater the concentration, the higher the rate of formation of the fluoride layer 23, whereas if the concentration exceeds 80%, the effect to increase the rate of formation of the fluoride layer 23 levels off to render the increase in the concentration unjustifiable and to result in the problem of an increased production cost. Accordingly, the fluorinating gas concentration is preferably 5 to 80%, more preferably 10 to 60%. Although various inert gases are usable such as N₂ gas, Ar gas and He gas, N₂ gas is especially preferable to use. For the fluorination treatment, the brazed assembly is held in the fluorinating atmosphere preferably at a temperature of at least 100° C. for at least 5 hours. If the holding temperature is less than 100° C. or the holding time is less than 5 hours, it is difficult to effect diffusion into the surface layer portions of the inner and outer surfaces of the plates 2 and the surfaces of the corrugated fins 7, 9, with the result that a satisfactory fluoride layer 23 becomes no longer available. Preferably, the holding temperature is at least 150° C. and the holding time is at least 10 hours. The upper limit of the holding temperataure is not higher than 600° C., and the upper limit of the holding time is not longer than 50 hours. The pressure of the fluorinating atmosphere is not limited specifically but can be set variously. Preferably, the pressure is in the range of 0.8×10⁵ to 1.5×10⁵ Pa.

In this way, the heat exchanger 1 is fabricated.

In the case where the heat exchanger 1 is used in a fuel cell system for use in fuel cell motor vehicles or cogeneration systems as a CO diminishing heat exchanger to reduce the CO concentration of the fuel hydrogen gas produced by the reformer as previously described, a catalyst for selectively oxidizing CO is provided on the outer peripheral surfaces of the flat hollow bodies, i.e., on the outer surfaces of the plates 2 and the surfaces of the outer corrugated fins 9.

FIG. 4 shows a modified plate for use as a heat exchanger component providing the flat hollow bodies 5 of the heat exchanger 1.

The plate 30 shown in FIG. 4 comprises a core layer 31 of pure aluminum or aluminum alloy, i.e., JIS A3003 alloy in this modification, two Al—Si alloy layers 32 covering respective opposite surfaces of the core layer 31, an intermediate layer 33 of pure aluminum, i.e., JIS A1050, formed between each of the Al—Si alloy layers 32 and the core layer 31, and a fluoride layer 34 formed in a surface layer portion of the Al—Si layer 32. The material for the core layer 31 is not limited to JIS A3003 alloy, nor is the material for the intermediate layer 33 limited to JIS A1050.

A major portion of the entire Al—Si alloy layer 32 is up to 1.65 mass % in Si content as is the case with the plate 2 shown in FIG. 3 and already described.

The intermediate layer 33 contains Si diffused thereinto from the Al—Si alloy layer 32. The diffused layer is indicated at 35. Preferably, the material JIS A1050 forming the intermediate layer 33 has added thereto Zr and/or Mg in a total amount of 0.1 to 0.25 mass %. The addition of Zr and/or Mg enlarges the crystal grains of JIS A1050 forming the layer 33, with the result that Al-12 mass % Si eutectic is no longer produced also in the diffused layer 35 containing Si diffused thereinto from the alloy layer 32. However, if the total amount of the element or elements is less than 0.1 mass %, this effect is not available, whereas amounts in excess of 0.25 mass % result in an increased cost. The total amount is therefore preferably 0.1 to 0.25 mass %. In view of the corrosion resistance and cost, the intermediate layer 33 has a thickness in a proportion of 5 to 25%, more preferably 15 to 25%, of the entire thickness taken as 100% of the plate 30.

The fluoride layer 34 comprises a fluoride produced by subjecting the surface of the Al—Si alloy layer 32 of the plate 30 to a fluorination treatment. For the same reason as in the case of the plate 2 shown in FIG. 3, the fluoride layer is preferably 2 nm to 10 μm, more preferably 20 nm to 3 μm, in thickness.

In the case where the heat exchanger 1 has flat hollow bodies 5 comprising such plates 30 and is used in a fuel cell system, for example, for use in fuel cell motor vehicles or cogeneration systems as a CO diminishing heat exchanger to reduce the CO concentration of the fuel hydrogen gas produced by the reformer, the Al—Si alloy layer 32 on the inner side of the flat hollow bodies 5, i.e., on the inner side of the plates 30, need not always be up to 1.65 mass % in Si content, nor is it necessary to provide the fluoride layer 34 in the surface layer portion thereof. Furthermore, the intermediate layer 33 need not be provided on the inner side of the plates 30. The reason is that the heat exchanger encounters no problem with respect to corrosion resistance even if exposed to water or water containing a long-life coolant.

In the case where a fluid containing an acid component is passed through both the fluid channels 3 and the gas-phase fluid channels 8, it is required to give an Si content of up to 1.65 mass % to a major portion of the Al—Si alloy layer 32 on the inner and outer peripheral surfaces of the flat hollow bodies 5, i.e., the inner and outer surfaces of the plates 30, to provide an intermediate layer 33 between each Al—Si alloy layer 32 and the core layer 31, and to form a fluoride layer 34 in a surface layer portion of the Al—Si alloy layer.

The heat exchanger 1 comprising the plate 30 shown in FIG. 4 is fabricated by the process to be described below.

First, a five-layer brazing sheet is prepared which comprises a core of pure aluminum or aluminum alloy, i.e., JIS A3003 alloy according to the present case, a cladding covering each of opposite sides of the core and made of Al-7.5-12.5 mass % Si alloy brazing material, i.e., JIS A4004 alloy brazing material in the present case, and an intermediate layer of pure aluminum, i.e., JIS A1050 in the present case, provided between the core and the cladding on each side of the core. Plates 30 are prepared from the brazing sheet by press work, each of the plates 30 having a channel-forming bulging portion 2a and a header-forming bulging portion 2b bulging to a greater extent than the bulging portion 2a and extending from each of opposite ends of the bulging portion 2a. Preferably, the intermediate layer 33 of the brazing sheet has added thereto Zr and/or Mg in a total amount of 0.1 to 0.25 mass %. The cladding of the brazing sheet has a thickness in a proportion of 2 to 25% of the entire thickness taken as 100% of the brazing sheet, and the intermediate layer 33 thereof has a thickness in a proportion of 5 to 25%, preferably 15 to 25%, of the entire thickness taken as 100% of the brazing sheet.

The plates 30 are then arranged in superposed pairs each comprising the combination of two plates 30 with openings of the bulging portions 2a (2b ) of each type opposed to each other in corresponding relation so that the outer surfaces of bottom walls of the header-forming bulging portions 2b of the adjacent pairs are in contact with each other. Outer corrugated fins 9 of bare pure aluminum or aluminum alloy, i.e., JIS A3003 alloy in the present cases, are arranged between portions corresponding to the channel-forming bulging portions 2a of the respective adjacent pairs of plates 30, and inner corrugated fins 7 of bare pure aluminum or aluminum alloy, i.e., JIS A3003 alloy in the present case, are arranged in the channel-forming bulging portions 2a of the respective pairs of plates 30.

The two preheated plates 30 in each pair are thereafter brazed to each other along the peripheral edge portions thereof to form a flat hollow body 5, and the corrugated fins 7, 9 are brazed to the flat hollow bodies 5. For this brazing, the assembly of components is preheated in the mode usual for brazing unlike the first process described.

The same fluorination treatment as in the first process described is thereafter performed to form a fluoride layer 34 over the inner and outer peripheral surfaces of the flat hollow bodies 5, i.e., the inner and outer surfaces of the plates 30, and the surfaces of the corrugated fins 7, 9.

In this way, the heat exchanger 1 is fabricated.

In the case where the heat exchanger 1 is used in a fuel cell system for use in fuel cell motor vehicles or cogeneration systems as a CO diminishing heat exchanger to reduce the CO concentration of the fuel hydrogen gas produced by a reformer as described above, a catalyst for selectively oxidizing CO is provided on the outer peripheral surfaces of the flat hollow bodies 5, i.e., on the outer surfaces of the plates 30 and the surfaces of the outer corrugated fins 9 after the fluorination treatment.

In the case where the heat exchanger 1 is used in a fuel cell system for use in fuel cell motor vehicles or cogeneration systems as a CO diminishing heat exchanger to reduce the CO concentration of the fuel hydrogen gas produced by a reformer as described above, a fluid containing no acid component, like the water containing a long-life coolant, flows through the fluid channels of the flat hollow bodies. Accordingly, a four-layer brazing sheet will be used which comprises a core of pure aluminum or aluminum alloy, i.e., JIS A3003 alloy according to the present case, a cladding covering each of opposite sides of the core and made of Al-7.5-12.5 mass % Si alloy brazing material, i.e., JIS A4004 alloy brazing material in the present case, and an intermediate layer of pure aluminum, i.e., JIS A1050 in the present case, provided between the core and the cladding on one side of the core. In producing plates 30 each having a channel-forming bulging portion 2a and a header-forming bulging portion 2b with a greater height than the bulging portion 2a and extending from each of opposite ends of the bulging portion 2a, the four-layer brazing sheet is subjected to press work, with the intermediate layer existing side thereof positioned as the outer side.

FIG. 5 shows another modified plate for use as a heat exchanger component of the flat hollow bodies 5 of the heat exchanger 1.

The plate 60 shown in FIG. 5 comprises a core layer 31 of pure-aluminum or aluminum alloy, i.e., JIS A3003 alloy in the present case, two Al—Si alloy layers 32 covering respective opposite surfaces of the core layer 31, an intermediate layer 33 made of pure aluminum, i.e., JIS A1050 in the present case, and formed between each of the Al—Si alloy layers 32 and the core layer 31, an anodic oxide coating 61 formed over the surface of each Al—Si alloy layer 32, a plating layer 62 containing nickel and formed over the surface of the anodic oxide coating 61, and a fluoride layer 63 formed over the surface of the plating layer 62, the intermediate layer 33 containing Si diffused thereinto from the Al—Si alloy layer 32 to provide a diffused layer 35.

The core layer 31, two Al—Si alloy layers 32, intermediate layers 33 and diffused layers 35 are the same as in the plate 30 shown in FIG. 4 and will not be described repeatedly.

The plating layer 62 comprises, for example, an electroless nickel plating or electroless nickel-phosphorus alloy plating. The fluoride layer 63 comprises a fluoride produced by subjecting the surface of the plating layer 62 to a fluorination treatment.

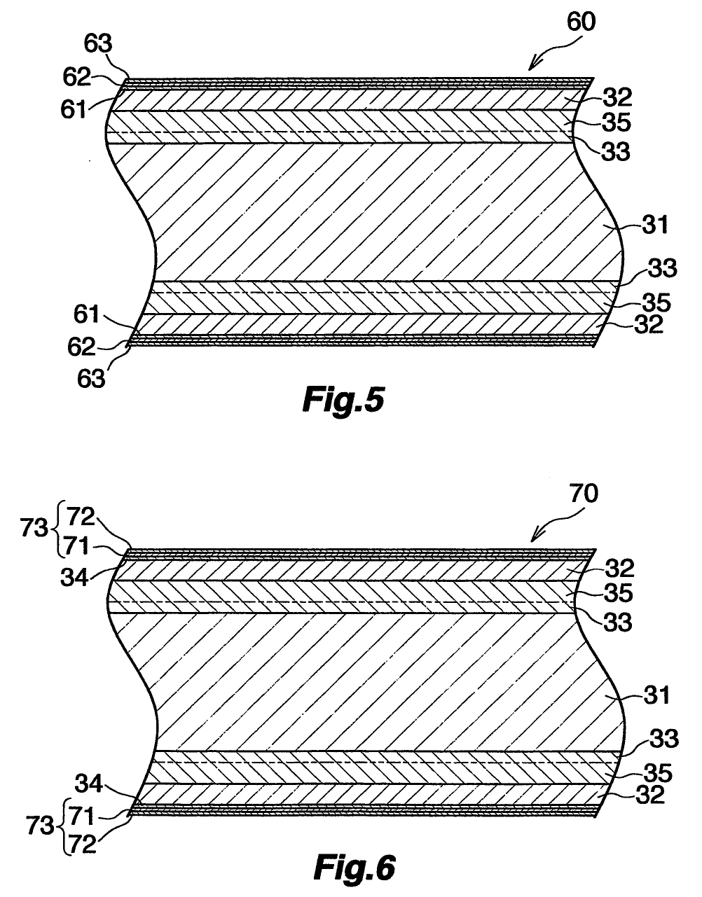

FIG. 6 shows another modified plate for use as a heat exchanger component of the flat hollow bodies 5 of the heat exchanger 1.

The plate 70 shown in FIG. 6 comprises a superposed layer group 73 provided on the surface of the fluoride layer 34 of the plate 30 shown in FIG. 4 and comprising a nickel-containing plating layer 71, and a fluoride layer 72 formed on the surface of the plating layer 71.

The plating layer 71 comprises, for example, an electroless nickel plating or electroless nickel-phosphorus alloy plating. The fluoride layer 72 comprises a fluoride produced by subjecting the surface of the plating layer 71 to a fluorination treatment. Although the superposed layer group 73 provided in the modification is one in number, this is not limitative; at least two layer groups may be provided. For example when two superposed layer group 73 are to be provided, a nickel-containing plating layer is formed on the surface of the fluoride layer 72 of the superposed layer group 73, and the surface of the plating layer is fluorinated to form on this surface a fluoride layer containing a fluoride produced by the fluorination. Three or more superposed layer groups are also so formed as to provide a fluoride layer 72 as the outermost layer.

In the case where the heat exchanger 1 has flat hollow bodies 5 comprising such plates 60 or 70 shown in FIG. 5 or 6 and is used in a fuel cell system, for example, for use in fuel cell motor vehicles or cogeneration systems as a CO diminishing heat exchanger to reduce the CO concentration of the fuel hydrogen gas produced by the reformer, the Al—Si alloy layer 32 on the inner side of the flat hollow bodies 5, i.e., on the inner side of the plates 60 or 70, need not always be up to 1.65 mass % in Si content, nor is it necessary to provide the anodic oxide coating 61, plating layer 61 and fluoride layer 63, or the fluoride layer 34 and superposed layer group 73 on the surface of the Al—Si alloy layer 32. Furthermore, the intermediate layer 33 need not be provided on the inner side of the plates 60 or 70. The reason is that the heat exchanger encounters no problem with respect to corrosion resistance even if exposed to water or water containing a long-life coolant.

In the case where a fluid containing an acid component is passed through both the fluid channels 3 and the gas-phase fluid channels 8, it is required to give an Si content of up to 1.65 mass % to a major portion of the Al—Si alloy layer 32 on the inner and outer peripheral surfaces of the flat hollow bodies 5, i.e., the inner and outer surfaces of the plates 60 or 70, to provide an intermediate layer 33 between each Al—Si alloy layer 32 and the core layer 31, and to form an anodic oxide coating 61, plating layer 62 and fluoride layer 63, or a fluoride layer 34 and superposed layer group 73 on the surface of the Al—Si alloy layer.

Given below are Experimental Examples wherein the advantage of the invention was substantiated, and Comparative Experimental Examples.

Test pieces X, measuring 100 mm in length, 50 mm in width and 0.4 mm in thickness, were prepared from a brazing sheet comprising a core of JIS A3003 alloy, two claddings of JIS A4004 alloy brazing material covering respective opposite sides of the core, and an intermediate layer formed between the core and one of the claddings and made of pure aluminum containing 0.15 mass % of Zr added thereto. The core, each of the claddings and the intermediate layer of the test piece X had thicknesses of 54%, 13% and 20%, respectively, relative to the entire thickness of the test piece X taken as 100%. Test pieces Y, measuring 100 mm in length, 50 mm in width and 0.5 mm in thickness, were prepared from a brazing sheet comprising a core of JIS A3003 alloy, and two claddings of JIS A4004 alloy brazing material covering respective opposite sides of the core. The core and each of the claddings of the test piece Y had thicknesses of 70% and 15%, respectively, relative to the entire thickness of the test piece Y taken as 100%.

### EXPERIMENTAL EXAMPLE 1

A test piece X was placed into a vacuum heating furnace, heated at 575° C. for 40 minutes and thereafter heated at 612° C. for 12 minutes. The test piece X was then taken out of the furnace and placed into an atmospheric heating furnace, a mixture of fluorine gas and an inert gas was introduced into the atmospheric heating furnace to provide a fluorinating atmosphere in the interior of the furnace, and the test piece X was heated at 400° C. for 24 hours for a fluorination treatment. The atmosphere had a fluorine gas concentration of 20%.

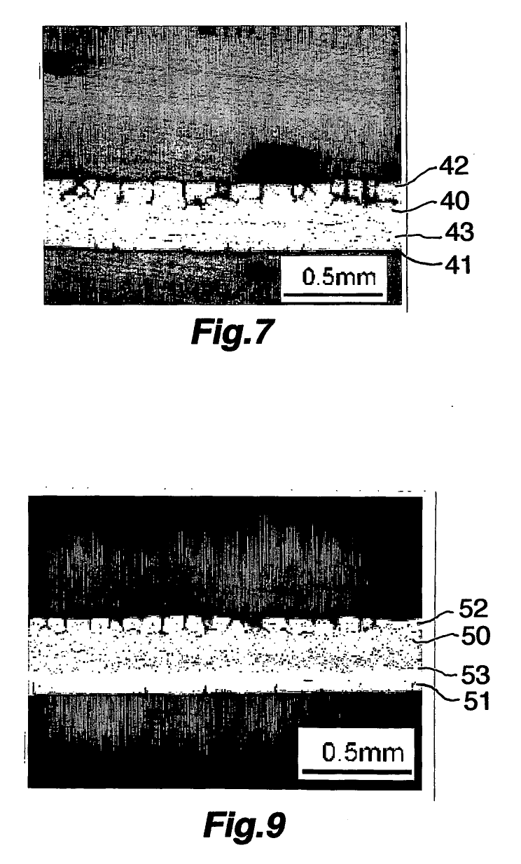

The test piece X was withdrawn from the furnace and checked for the appearance of a section thereof. FIG. 7 shows the result. With reference to FIG. 7, indicated at 40 is the core, at 41 the cladding adjacent to the intermediate layer, at 42 the cladding provided with no intermediate layer, and at 43 the intermediate layer. FIG. 7 reveals the following. The cladding-41 adjacent to the intermediate layer 43 has a surface remaining almost free of any change and contains no Al-12 mass % Si eutectic, whereas the cladding 42 provided with no intermediate layer exhibits marked surface irregularities and contains Al-12 mass % Si eutectic. This result indicates that the Si contained in the cladding 41 adjacent to the intermediate layer 43 diffused into the intermediate layer 43. On the other hand, the Si in the cladding 42 provided with no intermediate layer 43 remained undiffused, and the fluorination treatment caused the portion of Al-12 mass % Si eutectic to produce SiH₄, which evaporated off. It is also seen that the Al-12 mass % Si eutectic remained.

### EXPERIMENTAL EXAMPLE 2

A test piece X was treated under the same conditions as in Experimental Example 1 except that the holding temperature for the fluorination treatment was changed to 500° C.

When the test piece X was withdrawn from the atmospheric heating furnace and checked, the test piece was found to have a white smooth surface on the side thereof closer to the intermediate layer, while the test piece had marked surface irregularities on the opposite side.

### EXPERIMENTAL EXAMPLE 3

A test piece Y was placed into a vacuum heating furnace, heated at 575° C. for 40 minutes and thereafter heated at 612° C. for 12 minutes. The test piece Y was then taken out of the furnace temporarily, placed into the vacuum heating furnace again, heated at 575° C. for 40 minutes and thereafter heated at 612° C. for 12 minutes. The test piece Y was then taken out of the furnace and placed into an atmospheric heating furnace, and a mixture of fluorine gas and an inert gas was introduced into the atmospheric heating furnace to provide a fluorinating atmosphere in the interior of the furnace. The atmosphere had a fluorine gas concentration of 20%. The test piece Y was subsequently heated at 260° C. for 24 hours.

When the test piece Y was withdrawn from the furnace and checked, the test piece was found to have a white smooth surface.

### EXPERIMENTAL EXAMPLE 4

A test piece Y was treated under the same conditions as in Experimental Example 3 except that the holding temperature for the fluorination treatment was changed to 400° C.

When the test piece Y was withdrawn from the atmospheric heating furnace and checked, the test piece was found to have a brown smooth surface.

### EXPERIMENTAL EXAMPLE 5

A test piece Y was treated under the same conditions as in Experimental Example 3 except that the holding temperature for the fluorination treatment was changed to 500° C.

When the test piece Y was withdrawn from the atmospheric heating furnace and checked, the test piece was found to have a brown surface with minute irregularities.

### COMPARATIVE EXPERIMENTAL EXAMPLE 1

A test piece Y was placed into a vacuum heating furnace, heated at 575° C. for 40 minutes and thereafter heated at 612° C. for 12 minutes. The test piece Y was then taken out of the furnace and placed into an atmospheric heating furnace, a mixture of fluorine gas and an inert gas was introduced into the atmospheric heating furnace to provide a fluorinating atmosphere in the interior of the furnace, and the test piece Y was heated at 400° C. for 24 hours for a fluorination treatment. The atmosphere had a fluorine gas concentration of 20%.

When the test piece Y was withdrawn from the furnace and checked, the test piece was found to have marked surface irregularities.

### COMPARATIVE EXPERIMENTAL EXAMPLE 2

A test piece Y was treated under the same conditions as in Comparative Experimental Example 1 except that the holding temperature for the fluorination treatment was changed to 500° C.

When the test piece Y was withdrawn from the atmospheric heating furnace and checked, the test piece was found to have marked surface irregularities.

### EXPERIMENTAL EXAMPLE 6

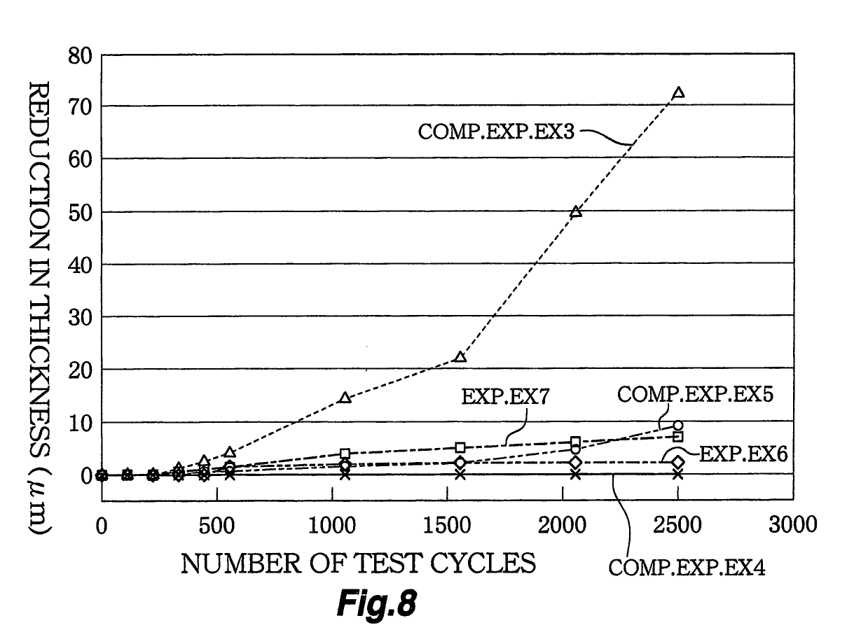

Test pieces X were treated under the same conditions as in Experimental Example 1. A corrosive aqueous solution was prepared which was 3 in pH and contained 10 ppm of hydrochloric acid, 50 ppm of nitric acid, 1000 ppm of formic acid and 300 ppm of acetic acid. Each of the test pieces X was heated at 50° C. for 15 minutes, then cooled in the air for 4 minutes, and thereafter immersed in the corrosive solution for 1 minute as a simulated corrosion cycle, and this cycle was repeated 2500 times for a corrosion test. The test piece X was checked for a reduction in the thickness thereof every time a predetermined number of corrosion cycles were completed. FIG. 8 shows the variations in the reduction of thickness of the test pieces.

### EXPERIMENTAL EXAMPLE 7

Test pieces Y were treated under the same conditions as in Experimental Example 4, subjected to the same corrosion test as in Experimental Example 6, and checked for a reduction in thickness every time a predetermined number of simulated corrosion cycles were completed. FIG. 8 shows the variations in the reduction of thickness.

### COMPARATIVE EXPERIMENTAL EXAMPLE 3

Test pieces Y were placed into a vacuum heating furnace, heated at 575° C. for 40 minutes and thereafter heated at 612° C. for 12 minutes. The test pieces Y were then taken out of the furnace and placed into an atmospheric heating furnace, and a mixture of fluorine gas and an inert gas was introduced into the atmospheric heating furnace to provide a fluorinating atmosphere in the interior of the furnace. The atmosphere had a fluorine gas concentration of 20%. The test pieces Y were subsequently heated at 260° C. for 24 hours.

The test pieces Y were subjected to the same corrosion test as in Experimental Example 6, and checked for a reduction in thickness every time a predetermined number of simulated corrosion cycles were completed. FIG. 8 shows the variations in the reduction of thickness.

### COMPARATIVE EXPERIMENTAL EXAMPLE 4

Test pieces made of JIS SUS304 and measuring 100 mm in length, 50 mm in width and 0.9 mm in thickness were subjected to the same corrosion test as in Experimental Example 6 and checked for a reduction in thickness every time a predetermined number of simulated corrosion cycles were completed. FIG. 8 shows the variations in the reduction of thickness.

### COMPARATIVE EXPERIMENTAL EXAMPLE 5

Test pieces made of JIS A3003 alloy and measuring 100 mm in length, 50 mm in width and 0.9 mm in thickness were placed into an atmospheric heating furnace, and a mixture of fluorine gas and an inert gas was introduced into the furnace to provide a fluorinating atmosphere in the interior of the furnace. The atmosphere had a fluorine gas concentration of 20%. The test pieces were then heated at 400° C. for 24 hours, thereafter subjected to the same corrosion test as in Experimental Example 6 and checked for a reduction in thickness every time a predetermined number of simulated corrosion cycles were completed. FIG. 8 shows the variations in the reduction of thickness.

The results shown in FIG. 8 reveal that the reductions in the thickness of test pieces due to corrosion and determined in Experimental Examples 6 and 7 are comparable to those of stainless steel, and that Comparative Experimental Example 3 results in marked reductions in thickness. It appears that the test pieces of Comparative Experimental Example 5 were subjected to the same conditions as the outer corrugated fins of heat exchangers. The result shown therefore substantiates that even when the heat exchanger of the invention is used in the fuel cell system for fuel cell motor vehicles or cogeneration systems for reducing the CO concentration of the fuel hydrogen gas produced by the reformer, the outer corrugated fins are not susceptible to corrosion.

### EXPERIMENTAL EXAMPLE 8

Test piece X were treated under the same conditions as in Experimental Example 2, then subjected to a corrosion test under the same conditions as in Experimental Example 6, and checked for the appearance of a section thereof. FIG. 9 shows the result. With reference to FIG. 9, indicated at 50 is the core, at 51 the cladding adjacent to the intermediate layer, at 52 the cladding provided with no intermediate layer, and at 53 the intermediate layer. FIG. 9 reveals the following. The cladding 51 adjacent to the intermediate layer 53 has a surface remaining almost free of any change and contains no Al-12 mass % Si eutectic, whereas the cladding 52 provided with no intermediate layer exhibits marked surface irregularities, and corrosion develops from Al-12 mass % Si eutectic in this cladding 52 to the core 50.

The plates 2, 30, i.e., heat exchanger components of the present invention, have high corrosion resistance not only to fluids containing an acid component but also to those containing an alkaline component.

Other embodiments of the present invention include pure aluminum or aluminum alloy products comprising a component which is similar in construction to the plates 2 and 30 described above, for example, a component in the form of a flat plate, bent plate or tube. With such pure aluminum or aluminum alloy products, at least one side or surface of the component is exposed to a fluid containing an acid component or alkaline component.

### INDUSTRIAL APPLICABILITY

The heat exchangers of the present invention are suitable for use in fuel cell systems useful, for example, for fuel cell motor vehicles or cogeneration systems for reducing the CO concentration of fuel gas (hydrogen gas)produced by a reformer.

1. A heat exchanger comprising a heat exchanger component having a surface covered with an Al—Si alloy layer, the Al—Si alloy layer having a fluoride layer formed in a surface layer portion thereof, the Al—Si alloy layer of the heat exchanger component having a portion up to 1.65 mass % in Si content.

2. A heat exchanger according to claim 1 wherein the fluoride layer is 2 nm to 10 μm in thickness.

3. A heat exchanger according to claim 1 wherein the fluoride layer comprises a fluoride produced by subjecting a surface of the Al—Si alloy layer of the heat exchanger component to a fluorination treatment.

4. A heat exchanger according to claim 1 wherein an anodic oxide coating is formed over a surface of the Al—Si alloy layer of the heat exchanger component, and a plating layer containing nickel is formed over a surface of the anodic oxide coating, the fluoride layer being formed on a surface of the plating layer and comprising a fluoride produced by subjecting the surface of the plating layer to a fluorination treatment.

5. A heat exchanger according to claim 1 wherein the fluoride layer is provided over a surface thereof with at least one superposed layer group comprising a plating layer containing nickel and a fluoride layer comprising a fluoride produced by subjecting a surface of the plating layer to a fluorination treatment.

6. A heat exchanger according to claim 1 wherein the heat exchanger component comprises a core layer of pure aluminum or aluminum alloy, and an Al—Si alloy layer covering each of opposite surfaces of the core layer, the core layer containing Si diffused thereinto from the Al—Si alloy layer, the Al—Si alloy layer having a portion up to 1.65 mass % in Si content.

7. A heat exchanger according to claim 6 wherein at least one surface of the heat exchanger component is exposed to a fluid containing an acid component.

8. A heat exchanger according to claim 1 wherein the heat exchange component has a portion comprising a core layer of pure aluminum or aluminum alloy, and two Al—Si alloy layers covering respective opposite surfaces of the core layer, and an intermediate layer of pure aluminum is formed between one of the Al—Si alloy layers and the core layer, the intermediate layer containing Si diffused thereinto from the Al—Si alloy layer, the Al—Si alloy layer adjacent to the intermediate layer having a portion up to 1.65 mass % in Si content.

9. A heat exchanger according to claim 1 wherein the heat exchange component comprises a core layer of pure aluminum or aluminum alloy, and two Al—Si alloy layers covering respective opposite surfaces of the core layer, and an intermediate layer of pure aluminum is formed between each of the Al—Si alloy layers and the core layer, the intermediate layer containing Si diffused thereinto from the Al—Si alloy layer, the Al—Si alloy layer having a portion up to 1.65 mass % in Si content.

10. A heat exchanger according to claim 8 or 9 wherein the pure aluminum making the intermediate layer has added thereto Zr and/or Mg in a total amount of 0.1 to 0.25 mass %.

11. A heat exchanger according to claim 8 or 9 wherein the intermediate layer has a thickness in a proportion of 5 to 25% of the entire thickness taken as 100% of the heat exchanger component.

12. A heat exchanger according to claim 8 or 9 wherein a surface of the heat exchanger component on the side thereof where the intermediate layer exists is exposed to a fluid containing an acid component.

13. A heat exchanger according to claim 1 which comprises a plurality of parallel hollow bodies each having a fluid channel inside thereof and fins arranged between and brazed to respective pairs of adjacent flat hollow bodies, the heat exchanger component being each of the flat hollow bodies.

14. A heat exchanger according to claim 1 which comprises a plurality of parallel hollow bodies each having a fluid channel inside thereof and fins arranged between and brazed to respective pairs of adjacent flat hollow bodies, each of the hollow bodies comprising two plates brazed to each other at peripheral edge portions thereof, the two plates defining therebetween a bulging fluid channel and a bulging header-forming portion communicating with each of opposite ends of the fluid channel, the heat exchanger component being each of the plates.

15. A heat exchanger according to claim 13 or 14 wherein a fluid containing an acid component flows through at least one of the fluid channel inside each of the flat hollow bodies and a clearance between each pair of adjacent flat hollow bodies.

16. A heat exchanger according to claim 13 or 14 wherein fuel hydrogen gas produced by reforming in a fuel cell system flows through a clearance between each pair of adjacent flat hollow bodies, and an outer peripheral surface of each of the flat hollow bodies is covered with an Al—Si alloy layer, a fluoride layer being formed in a surface layer portion of the Al—Si alloy layer, the Al—Si alloy layer having a portion up to 1.65 mass % in Si content, a catalyst for selectively oxidizing CO being provided on the outer peripheral surface of each of the flat hollow bodies and on a surface of each of the fins, the catalyst being serviceable to diminish CO in the fuel hydrogen gas.

17. A fuel cell system comprising a heat exchanger according to any one of claims 1 to 16 for diminishing Co.

18. A fuel cell motor vehicle having installed therein a fuel cell system according to claim 17.

19. A cogeneration system comprising a fuel cell system according to claim 17.

20. A process for fabricating a heat exchanger characterized by making plates each having a channel-forming bulging portion and a header-forming bulging portion bulging to a greater extent than the bulging portion and extending from each of opposite ends of the channel-forming bulging portion, from a brazing sheet comprising a core of pure aluminum or aluminum alloy and a cladding of Al-7.5-12.5 wt. % Si alloy brazing material covering each of opposite sides of the core, arranging the plates in superposed pairs each comprising the combination of two plates with openings of the bulging portions of each type opposed to each other in corresponding relation so that outer surfaces of bottom walls of the header-forming bulging portions of the adjacent pairs are in contact with each other and arranging fins of bare pure aluminum or aluminum alloy between portions corresponding to the channel-forming bulging portions of the respective adjacent pairs of plates, preheating the resulting combination of the pairs of plates and the fins to diffuse the Si in the cladding of the brazing sheet providing the plates into the core, brazing the two preheated plates in each pair to each other along the peripheral edge portions thereof to form a flat hollow body, brazing the fins to the respective adjacent pairs of flat hollow bodies, and heating the brazed assembly of the flat hollow bodies and the fins in an atmosphere containing a fluorinating gas to form a fluoride layer over surfaces of the flat hollow bodies and surfaces of the fins.

21. A process for fabricating a heat exchanger characterized by making plates each having a channel-forming bulging portion and a header-forming bulging portion bulging to a greater extent than the bulging portion and extending from each of opposite ends of the channel-forming bulging portion, from a brazing sheet comprising a core of pure aluminum or aluminum alloy, a cladding of Al-7.5-12.5 wt. % Si alloy brazing material covering each of opposite sides of the core, and an intermediate layer of pure aluminum formed between the core and the cladding over at least one of the opposite sides thereof, arranging the plates in superposed pairs each-comprising the combination of two plates with openings of the bulging portions of each type opposed to each other in corresponding relation so that outer surfaces of bottom walls of the header-forming bulging portions of the adjacent pairs are in contact with each other and arranging fins of bare pure aluminum or aluminum alloy between portions corresponding to the channel-forming bulging portions of the respective adjacent pairs of plates, preheating the resulting combination of the pairs of plates and the fins to diffuse the Si in the cladding of the brazing sheet providing the plates into the core, brazing the two preheated plates in each pair to each other along the peripheral edge portions thereof to form a flat hollow body, brazing the fins to the respective adjacent pairs of flat hollow bodies, and heating the brazed assembly of the flat hollow bodies and the fins in an atmosphere containing a fluorinating gas to form a fluoride layer over a surface of each of the flat hollow bodies on the core side thereof where the intermediate layer exists and over surfaces of the fins.

22. A process for fabricating a heat exchanger according to claim 21 wherein the pure aluminum providing the intermediate layer of the brazing sheet making the plates has added thereto Zr and/or Mg in a total amount of 0.1 to 0.25 mass %.

23. A process for fabricating a heat exchanger according to claim 21 wherein the intermediate layer of the brazing sheet providing the plates has a thickness in a proportion of 5 to 25% of the entire thickness taken as 100% of the brazing sheet.

24. A process for fabricating a heat exchanger according to claim 20 or 21 wherein the core of the brazing sheet providing the plates and the fins are each made of JIS A3003 alloy.

25. A process for fabricating a heat exchanger according to claim 20 or 21 wherein the cladding of the brazing sheet providing the plates has a thickness in a proportion of 2 to 25% of the entire thickness taken as 100% of the brazing sheet.

26. A process for fabricating a heat exchanger according to claim 20 or 21 wherein the fluorinating gas is at least one gas selected from the group consisting of fluorine gas, chlorine trifluoride gas and nitrogen fluoride gas, and the fluorinating gas is diluted with an inert gas to prepare the atmosphere.

27. A process for fabricating a heat exchanger according to claim 26 wherein the atmosphere contains the fluorinating gas at a concentration of 5 to 80%.

28. A process for fabricating a heat exchanger according to claim 26 wherein the atmosphere contains the fluorinating gas at a concentration of 10 to 60%.

29. A process for fabricating a heat exchanger according to claim 20 or 21 wherein a catalyst for selectively oxidizing CO is provided on outer peripheral surfaces of the flat hollow bodies and on surfaces of the fins after the fluoride layer is formed.

30. A product of pure aluminum or aluminum alloy comprising a component having a surface covered with an Al—Si alloy layer, the Al—Si alloy layer having a fluoride layer formed on a surface layer portion thereof, the Al—Si alloy layer of the component having a portion up to 1.65 mass % in Si content.

31. A product of pure aluminum or aluminum alloy according to claim 30 wherein the fluoride layer is 2 nm to 10 μm in thickness.

32. A product of pure aluminum or aluminum alloy according to claim 30 wherein the fluoride layer comprises a fluoride produced by subjecting a surface of the Al—Si alloy layer of the component to a fluorination treatment.

33. A product of pure aluminum or aluminum alloy according to claim 30 wherein an anodic oxide coating is formed over a surface of the Al—Si alloy layer of the component, and a plating layer containing nickel is formed over a surface of the anodic oxide coating, the fluoride layer being formed over a surface of the plating layer and comprising a fluoride produced by subjecting the surface of the plating layer to a fluorination treatment.

34. A product of pure aluminum or aluminum alloy according to claim 30 wherein the fluoride layer is provided over a surface thereof with at least one superposed layer group comprising a plating layer containing nickel and a fluoride layer comprising a fluoride produced by subjecting a surface of the plating layer to a fluorination treatment.

35. A product of pure aluminum or aluminum alloy according to claim 30 wherein the component comprises a core layer of pure aluminum or aluminum alloy, and an Al—Si alloy layer covering each of opposite surfaces of the core layer, the core layer containing Si diffused thereinto from the Al—Si alloy layer, the Al—Si alloy layer having a portion up to 1.65 mass % in Si content.

36. A product of pure aluminum or aluminum alloy according to claim 35 wherein at least one surface of the component is exposed to a fluid containing an acid component or alkaline component.

37. A product of pure aluminum or aluminum alloy according to claim 30 wherein the component has a portion comprising a core layer of pure aluminum or aluminum alloy, and two Al—Si alloy layers covering respective opposite surfaces of the core layer, and an intermediate layer of pure aluminum is formed between one of the Al—Si alloy layers and the core layer, the intermediate layer containing Si diffused thereinto from the Al—Si alloy layer, the Al—Si alloy layer adjacent to the intermediate layer having a portion up to 1.65 mass % in Si content.

38. A product of pure aluminum or aluminum alloy according to claim 30 wherein the component comprises a core layer of pure aluminum or aluminum alloy, and two Al—Si alloy layers covering respective opposite surfaces of the core layer, and an intermediate layer of pure aluminum is formed between each of the Al—Si alloy layers and the core layer, the intermediate layer containing Si diffused thereinto from the Al—Si alloy layer, the Al—Si alloy layer having a portion up to 1.65 mass % in Si content.

39. A product of pure aluminum or aluminum alloy according to claim 37 or 38 wherein the pure aluminum making the intermediate layer has added thereto Zr and/or Mg in a total amount of 0.1 to 0.25 mass %.

40. A product of pure aluminum or aluminum alloy according to claim 37 or 38 wherein the intermediate layer has a thickness in a proportion of 5 to 25% of the entire thickness taken as 100% of the component.

41. A product of pure aluminum or aluminum alloy according to claim 37 or 38 wherein a surface of the component on the side thereof where the intermediate layer exists is exposed to a fluid containing an acid component or alkaline component.
